(19) United States
(12) Patent Application Publication
(10) Pub. No.: US 2025/0004208 A1
(43) Pub. Date: Jan. 2, 2025

(54) PHOTONIC OPTICAL FIBER PACKAGING

(71) Applicant: International Business Machines Corporation, Armonk, NY (US)

(72) Inventors: Nicholas Alexander POLOMOFF, Hopewell Junction, NY (US); Nicholas Latham, Albany, NY (US); Junwon Han, Loudonville, NY (US); Kishan Jayanand, Cohoes, NY (US); Mary McGahay, Troy, NY (US); Sathyanarayanan Raghavan, Ballston Lake, NY (US); Aakrati Jain, Albany, NY (US)

(21) Appl. No.: 18/342,127

(22) Filed: Jun. 27, 2023

(51) Int. Cl. G02B 6/36

(52) U.S. Cl. CPC G02B 6/3616

(57) ABSTRACT

A lid for a photonic device includes a resilient frame configured to bridge transversely over one or more optical fibers in a region of the photonic device. The resilient frame includes a span that defines a span direction, the resilient frame further includes end portions that are disposed transversely to the span to form an internal region of the frame. A compliant solid base material is formed within the internal region of the frame and attached to the frame along the span. The resilient frame is configured to transversely span over one or more optical fibers and preload the one or more optical fibers with the compliant solid base material when secured to the photonic device.

### BACKGROUND

The present invention generally relates to optical fiber systems, and more particularly to devices and methods for protecting and maintaining alignment of optical fibers in semiconductor packaging.

Lateral photonic fiber attachment to a semiconductor build is subject to varied types of chip package integration (CPI) issues. Varying external energies and environmental conditions are exerted upon a fiber assembly, which results in the photonic fibers becoming dislodged and misaligned with their respect to photonic waveguide structures in a semiconductor die. Current optical fiber packaging does not address the risks of CPI related concerns. Force of impact, vibration, thermal cycling and prevention of moisture are not mitigated through current designs. In an array of fibers, some fibers can be misaligned during packaging or after being secured in packaging. Even slight misalignment of fibers can result in significant optical signal degradation.

### SUMMARY

In accordance with an embodiment of the present invention, a lid for a photonic device includes a resilient frame configured to bridge transversely over one or more optical fibers in a region of the photonic device. The resilient frame includes a span that defines a span direction. The resilient frame further includes end portions that are disposed transversely to the span to form an internal region of the frame. A compliant solid base material is formed within the internal region of the frame and attached to the frame along the span. The resilient frame is configured to transversely span over one or more optical fibers and preload the one or more fibers with the compliant solid base material when secured to the photonic device.

In accordance with another embodiment of the present invention, a lid for a photonic device includes a resilient frame configured to bridge transversely over one or more optical fibers in a region of the photonic device. A compliant solid base material is formed on a first side of the frame. The one or more fibers are positioned on the photonic device, and the resilient frame is configured to transversely span over the one or more optical fibers and preload the one or more fibers with the compliant solid base material when secured to the photonic device.

In accordance with yet another embodiment of the present invention, a lid assembly for a photonic device includes a resilient frame configured to bridge transversely over one or more optical fibers in a region of the photonic device, the resilient frame including a span that defines a span direction, the resilient frame further including end portions that are disposed transversely to the span to form an internal region of the frame. A compliant solid base material is formed with the internal region of the frame and is attached to the frame along the span. A fiber receiving trough, disposed in the photonic device, is configured to receive the one or more optical fibers, the one or more fibers being positioned on the photonic device in communication with corresponding waveguides disposed on the photonic device. The resilient frame is configured to transversely span over the one or more optical fibers and preload the one or more fibers with the compliant solid base material when secured to the photonic device in a transition region between the waveguides on the photonic device and the one or more fibers, which extend off the photonic device.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a cross-sectional view showing an optical fiber package having a lid in accordance with an embodiment of the present invention;

FIG. 2 is a perspective cross-sectional view showing an optical fiber package having a lid separated in accordance with an embodiment of the present invention;

FIG. 3 is a perspective cross-sectional view showing the optical fiber package of FIG. 2 having the lid installed in accordance with an embodiment of the present invention;

FIG. 4 is a top view showing an optical fiber package having the lid installed in accordance with an embodiment of the present invention;

FIG. 5 is a plan view showing a cushion surface of a compliant solid base material employed in securing and protecting optical fibers in accordance with an embodiment of the present invention;

FIG. 6 is a diagram showing an illustrative manufacturing method showing stages for fabricating a lid in accordance with an embodiment of the present invention; and

FIG. 7 is a diagram showing another illustrative manufacturing method showing stages for fabricating a lid in accordance with an embodiment of the present invention.

### DETAILED DESCRIPTION

In accordance with embodiments of the present invention, a packaging structure is provided for photonic device packaging and assembly. The packaging structure includes accommodation for receiving one or more optical or photonic fibers. The optical fibers can include a glass or plastic core surrounded by cladding. In some embodiments, additional materials and layers may be employed. The packaging structure includes a lid portion and a fiber receiving trough.

The fiber receiving trough receives one or more photonic fibers therein. The trough can include v-grooves or other shaped channels for cradling a lower portion of the photonic fibers. The lid portion includes a frame which includes a span between end portions. In operation securing photonic fibers, the span is disposed transversely to a longitudinal axis of the photonic fibers. The span can include a compliant solid base material to maintain a substantially constant pressure transversely across the photonic fibers. In some embodiments, metal, plastic, ceramic or other materials that have a stiffness with some elasticity can be employed for the span. In some embodiments, the span or frame can include a combinations of materials, e.g., plastic, metal and/or ceramic.

The compliant solid base material can have malleable or deformable properties to permit a slight preload or pressure while conforming (e.g., form-fitting) to surface of the optical fibers and other surfaces to which the compliant material is in contact. The optical fibers are not merely encapsulated in a potting adhesive and covered with a glass slide as in conventional systems.

The frame is configured to receive the compliant solid base material. The compliant solid base material provides both elastic and plastic mechanical properties. The base material is conforming to contour to a shape of the photonic fibers yet elastic enough to apply a downward pressure to maintain the photonic fibers in the fiber receiving trough when in operating with the frame. In useful embodiments, the compliant solid base material can include an elastomeric polymer, such as an organic polymer, synthetic rubber, etc. In one embodiment, the polymer includes a foam material, e.g., an elastomeric closed cell foam.

The lid is configured to maintain the photonic fibers firmly in their positions (e.g., within the v-groove of fiber receiving portion) without misalignment. The malleable or compliant solid base material (e.g., polymer) will push, position and hold photonic fibers into correct alignment of the photonic fibers to their respective waveguides to secure and align the photonic fibers to the fiber receiving portion.

The lid assembly with compliant solid base material further provides cushioning support. This ensures proper positioning of the photonic fibers during assembly and during operation. The base material minimizes impact of vibration on optical fibers by its dampening properties, which also can absorb vibration and shock forces or impacts on the photonic fibers. Further, the base material can prevent the formation of moisture and swelling of key areas around the photonic fibers. This can be achieved by sealing the photonic fibers at a junction point (high stress area or transition region) with on-chip waveguides. The base material also secures the photonic fibers during operational thermal cycling, maintaining a pressure preload throughout the operational temperature range.

By securing the photonic fibers, dampening external forces, maintaining a pressure preload and excluding moisture, the packaging structure in accordance with embodiments of the present invention improves the reliability and consistency of optical signal performance and reduces the likelihood of developing microcracks in optical fiber cladding.

In particularly useful embodiments, the packaging structure can employ a mechanical only interface with the photonic fibers. In this way the photonic fibers are free from adhesives normally used to pot or secure the photonic fibers. Such adhesives can impart stress and movement to the photonic fibers during curing, thermal cycling or can wind up on other surfaces where the presence of adhesive material would be detrimental. The packaging structure provides superior protection over conventional fiber attachment styles (e.g., with adhesive and glass lids) against chip-package integration (CPI) related threats due to the compliant nature embedded into the structure. Such CPI related threats cover many external energies or threats such as mechanical vibrations, thermal expansion cycling, moisture/humidity threats (e.g., ingress/swelling of surrounding dielectric), bending, bowing, warpage of substrate of package, moisture or perhaps bending/of the base substrate or thermal expansion of materials, etc.

Exemplary applications/uses to which the present invention can be applied include, but are not limited to photonic devices including chips with fiber optic connections, fiber optic couplers, optical equipment, semiconductor devices connected by optical fibers or any other interface where optic fibers are mechanically connected.

It is to be understood that aspects of the present invention will be described in terms of a given illustrative architecture; however, other architectures, structures, substrate materials and process features and steps can be varied within the scope of aspects of the present invention.

It will also be understood that when an element such as a layer, region or substrate is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The present embodiments can include a design for an integrated circuit chip, which can be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer can transmit the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

Methods as described herein can be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should also be understood that material compounds will be described in terms of listed elements, e.g., SiGe. These compounds include different proportions of the elements within the compound, e.g., SiGe includes SiₓGe₁₋ₓ where x is less than or equal to 1, etc. In addition, other elements can be included in the compound and still function in accordance with the present principles. The compounds with additional elements will be referred to herein as alloys.

Reference in the specification to “one embodiment” or “an embodiment”, as well as other variations thereof, means that a particular feature, structure, characteristic, and so forth described in connection with the embodiment is included in at least one embodiment. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising.” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper.” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

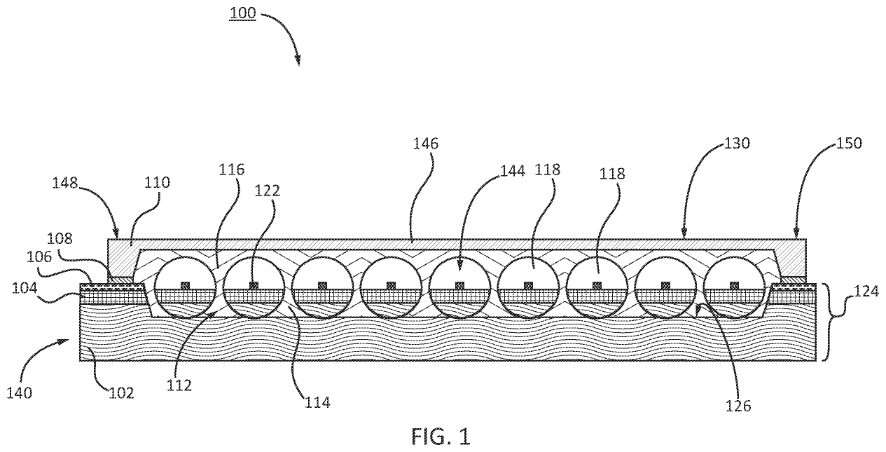

Referring now to the drawings in which like numerals represent the same or similar elements and initially to FIG. 1, a cross-sectional view of a photonic device or photonic fiber assembly 100 employed in a packaging structure is shown in accordance with one embodiment of the present invention. The photonic fiber assembly 100 includes a photonic chip portion 124 having a fiber receiving trough or channel 126 formed therein. The channel 126 receives one or more optical fibers 118 therein. The optical fibers align with waveguides 122 that are disposed on or within a main surface of the photonic chip portion 124. The optical fibers 118 can be seated in a potting material 114, such as an adhesive material, e.g., poly (urea-urethane) or can be seated in a compliant solid base material similar to that of compliant solid base material 116. In other embodiments, the channel 126 can be configured with slots, v-grooves or other channel shapes configured to receive the optical fibers 118 and to hold and maintain the optical fibers 118 during assembly and in-use of the photonic fiber assembly 100.

A lid portion or lid 130 is attached to the photonic chip portion 124 to form the photonic fiber assembly 100. The lid 130 can be attached to the photonic chip portion 124 using a connection portion 108, which can include adhesive, glue or a mechanical connection, such as snapping parts, screws, slots, etc. In some embodiments, both mechanical and adhesive materials can be employed to make the connection portion 108 of the lid 130 to the photonic chip portion 124.

The photonic chip portion 124 includes a substrate structure 140 having multiple layers formed thereon. The substrate structure 140 can include any suitable substrate structure, e.g., a bulk semiconductor, a semiconductor-on-insulator (SOI) substrate, etc.

FIG. 1 shows a SOI substrate structure 140 having a substrate 102, buried oxide (BOX) layer 104 and a semiconductor layer 106. In one example, the substrate 102 can include a silicon-containing material. Illustrative examples of Si-containing materials suitable for the substrate 102 can include, but are not limited to, Si, SiGe, SiGeC, SiC and multi-layers thereof. Although silicon is the predominantly used semiconductor material in wafer fabrication, alternative semiconductor materials can be employed as additional layers, such as, but not limited to, germanium, gallium arsenide, gallium nitride, silicon germanium, cadmium telluride, zinc selenide, etc. The BOX layer 104 can include a silicon oxide (e.g. SiO₂). The semiconductor layer 106 can include a Si-containing material, e.g., Si, SiGe, SiGeC, SiC and multi-layers thereof. In one example, the semiconductor layer 106 can include p-doped Si. Alternative semiconductor materials can be employed for the semiconductor layer 106, such as, but not limited to, germanium, gallium arsenide, gallium nitride, silicon germanium, cadmium telluride, zinc selenide, etc.

The semiconductor layer 106, BOX layer 104 and substrate 102 can be patterned by lithographical process techniques to form fiber receiving trough or channel 126. In other embodiments, the channel 126 can include partitions, slots, v-grooves or other structures configured to receive optical fibers 118 therein. In one embodiment, the channel 126 is formed deep enough to receive greater than one half of the cross-sectional area of the optical fiber 118. For example, the centerline of the optical fibers 118 is below a top surface of the semiconductor layer 106. The optical fibers include a cladding 144 that surrounds an optical core (not shown). The optical core of the fiber is aligned with a waveguide 122 (into the page of FIG. 1) that extends down the photonic chip portion 124. The cladding 144 of the optical fibers 118 should be in contact with the substrate 102 as the substrate 102 provides a rigid interface against a lower surface, point or points of the optical fiber 118 of the which reliable alignment and/or maintenance of that alignment can be achieved.

In accordance with embodiments of the present invention, the lid 130 includes a frame 110 having a span 146 between transversely disposed end portions 148 and 150, relative to the span 146. To secure the optical fibers 118 in the channel 126, the span 146 is disposed transversely to a longitudinal axis of the optical fibers 118. The frame 110 and, in particular, the span 146 can include a resilient material to maintain a substantially constant pressure transversely across the optical fibers 118. In useful embodiments, the frame 110 can be comprised of metal, plastic, ceramic or combinations of these and other materials to provide stiffness with some elasticity to preload the compliant solid base material 116 in contact with the optical fibers 118.

The frame 110 is configured to receive the compliant solid base material 116. The compliant solid base material 116 provides both elastic and plastic mechanical properties. The base material 116 is malleable to contour to a shape of the optical fibers 118 yet elastic enough to apply a downward pressure to maintain the optical fibers 118 in the fiber receiving trough or channel 126 when assembled. In useful embodiments, the compliant solid base material 116 can include an elastomeric polymer, such as, an organic polymer or a synthetic rubber blend.

Organic polymers can include polyethylene (PE), polystyrene (PS), polypropylene, polyvinyl chloride (PVC), polymethylmethacrylate (PMMA), polyphenylene oxide (PPO), acrylonitrile butadiene styrene (ABS), poly-(2-hydroxyethyl methacrylate), poly (vinyl alcohol) gel, poly (acryl amide) gel, polydimethylsiloxane (PDMS), polyester, nylon, acrylonitrile butadiene styrene (ABS), acetals or combinations of these or other materials.

The synthetic rubber blend can include, e.g., nitrile butadine rubber (NBR), epichlorohydrin (ECH), ethylene propylene diene monomer (EPDM), chloroprene (CR), styrene-butadiene rubber (SBR). The compliant solid base material 116 can include a closed cell structure or a solid foam to provide the elastomeric properties needed to maintain the optical fibers 118 in position and dampen any shock or vibration forces during operation. In useful embodiments, the compliant solid base material 116 can be textured to provide additional deformability and flexure. The compliant solid base material 116 may include a thickness greater than the cladding diameter. In one embodiment, the compliant solid base material 116 fills gaps or lateral spaces around an optical fiber or between the cladding 144 of optical fibers 118.

In other useful embodiments, the compliant solid base material 116 includes fillers or air pockets to provide the compliant material properties needed to address CPI issues. The fillers can include pellets or particles, etc. of one of more of the materials listed for the solid base material 116 or another material or materials to achieve the properties needed. The fillers can be added to a matrix of the compliant solid base material during its formation (e.g., before curing from a liquid phase). The compliant solid base material 116 can also include one or more layers of a same or different material. In one embodiment, a layer in contact with the optical fibers 118 can include a softest material and material layers can be progressively more resilient toward the frame 110.

Given elevated temperatures of photonic devices during operation, conventional fiber adhesives can soften and relax and can misalign the fibers. Further, vibrations, thermal cycling, moisture swelling, shock impacts, etc. can also misalign the fibers. These misalignments can occur during assembly, but are more detrimental if they happen during operation. Small misalignments of fibers, e.g., less than one micron, can cause significant signal degradation and signal errors. As an example, a one micron misalignment between waveguides and optical fibers could result in an optical coupling loss on the order of 1-4 dB.

In accordance with embodiments of the present invention, curable adhesives are not relied upon to secure and protect the optical fibers 118. Instead, the optical fibers 118 are secured using a frame 110 and base material 116 to secure and protect the optical fibers 118 from moisture or external energies or forces resulting in CPI related threats.

In one embodiment, the compliant solid base material 116 can include a compression of less than about 5 psi. In one embodiment, the compliant solid base material 116 can include a compression deflection range at 25% deflection of between about 0.25 psi to about 4 psi. The hardness of the base material 116 can include a hardness (Shore Hardness) between about 10-30 (Durometer). The base material 116 can include a water absorption by weight of less than about 5%. A maximum temperature that the base material 116 should be exposed to without degradation should be about 160° F. In some embodiments, the material can include an elastic modulus of between about 2-5 GPa, with 2-3 GPa being preferred. The parameters selected can be dependent on the type of channels or grooves supporting the underside of the optical fibers, the number of fibers in the array and other geometric and mechanical considerations.

The compliant solid base material 116 is fully removeable from the one or more optical fibers 118. This means that unlike potting adhesive, the compliant solid base material 116 can be repeatably removed from the optical fibers 118 without leaving a residue or permanently adhered material. Since the compliant solid base material 116 is solid, the compliant solid base material 116 can easily be disengaged from the cladding of the optical fibers 118. A lid 130 can be reapplied to secure the fibers even after it had been previously removed.

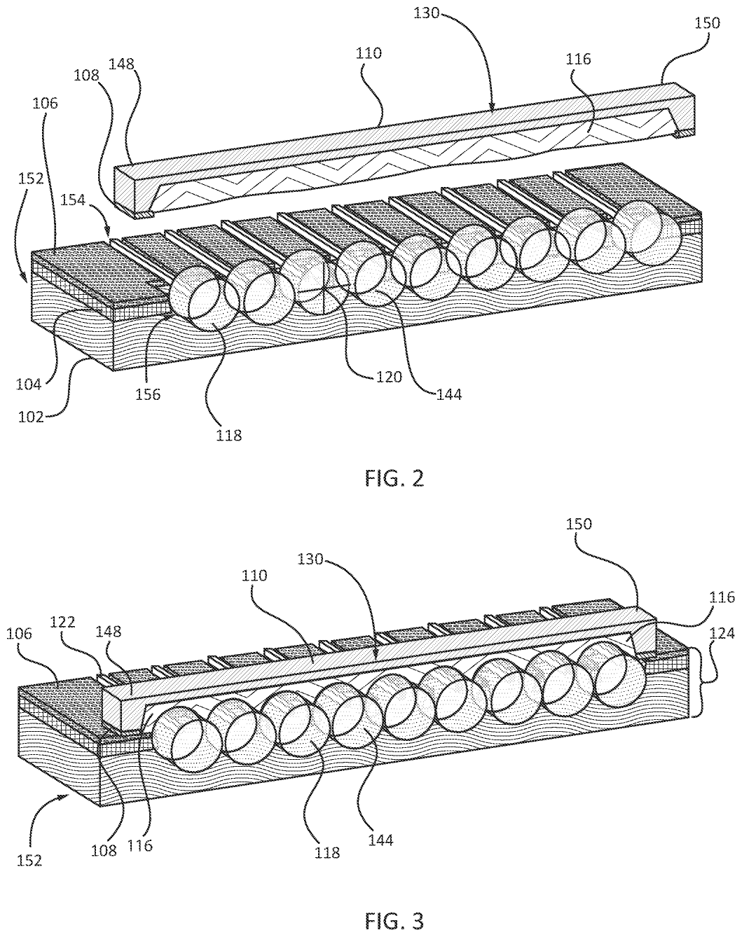

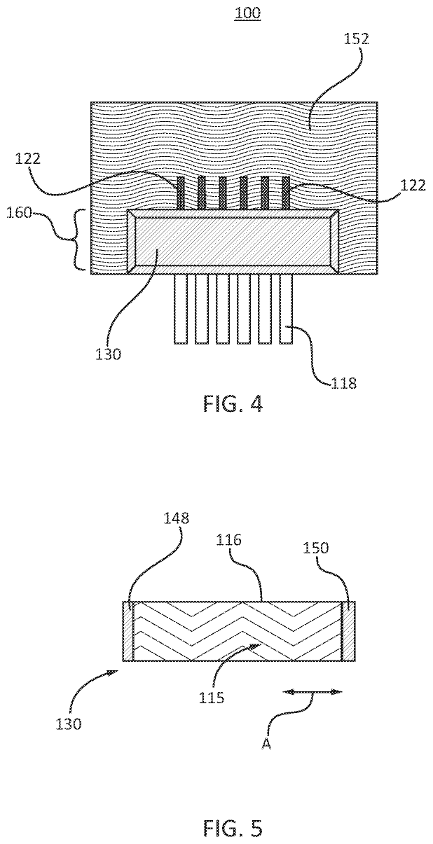

Referring to FIG. 2, an exploded perspective view is shown of the photonic fiber assembly 100 having the lid 130 shown separated from the photonic chip portion 124. With the lid 130 lifted, a top surface of the photonic chip 152 is shown. The compliant solid base material 116 is in its initial undeformed state. The photonic chip 152 includes a plurality of channels 154 each having an optical receiving waveguide 122 disposed therein. Optical fibers 118 are mounted on the photonic chip 152 and have their optical core 120 aligned to the waveguides 122 so that optical communication can occur therebetween. The cladding 144 is much larger than the core 120 and the waveguides 122. It is therefore a high stress area in a transition region between the optical fibers 118 and the waveguides 122. The lid 130 extends over this region (see e.g., FIG. 4).

The optical fibers 118 are depicted within a groove 156 formed in the substrate 102 and contoured to receive the cladding 144. The groove 156 includes a depth that aligns the waveguide 122 to the core 120 of the optical fiber 118.

In addition to the transition region between the optical fibers 118 and the waveguides 122, the lid 130 can extend over the optical fibers 118 in a direction away from the photonic chip 152 and can extend over a portion of the photonic chip 152 in a direction further over the waveguides 122. In this way, shock and vibrational energy traveling longitudinally down the optical fibers 118 and/or along the waveguides 122 is dampened before reaching the transition region between the optical fibers 118 and the waveguides 122. In addition, the base material 116 provides a seal to prevent moisture from entering the transition region between the optical fibers 118 and the waveguides 122. Vibration, shock forces, moisture, humidity, thermal cycles, etc. all increase the risk of formation of microcracks in glass in optical fibers 118. In addition, the optical fibers 118 are secured in place to avoid any developing misalignments due to these chip-to-package integration issues.

Referring to FIG. 3, a perspective view is shown of the photonic fiber assembly 100 having the lid 130 shown positioned over the waveguides 122 and end portions of the cladding 144. The lid 130 traverses the waveguides 122 and contours over the top surface of the photonic chip 152. The lid 130 can be secured using an adhesive for connection portion 108. Ends of the cladding 144 are secured around the top circumference of the cladding as well as the cleaved end facing the waveguides 122. The conformal nature of the base material 116 permits the base material to contour against all the surfaces to provide a snug and secure fit. The frame 110 is stiff enough so that flexing is not significant to ensure that the optical fibers 118 cannot move under the pressure provided by the base material 116.

The cladding 144 is much larger than the core 120 and the waveguides 122. It is therefore a high stress area in a transition region between the optical fibers 118 and the waveguides 122. The lid 130 extends over this region (see e.g., transition region 160, FIG. 4). Further, the lid 130 can be removed without damage to the optical fibers 118.

Referring to FIG. 4, a top view of the photonic fiber assembly 100 is shown. The lid 130 is secured over a transition region 160 between the waveguides 122 and the optical fibers 118. The lid 130 can be secured in place by adhesive, glue or an attachment mechanism.

It should be understood that while a photonic chip 152 is shown, any device having an optical fiber interface can employ embodiments of the present invention. The optical fibers 118 can include single mode fibers, multimode fibers, other waveguides or combinations of these or other optical signal carriers.

Referring to FIG. 5, a plan view of the base material 116 on the lid 130 is shown. In one embodiment, the base material 116 can be formed within the frame 110 of the lid 130. This includes fabricating the lid 130 followed by pouring, in a liquid form, the base material 116 and curing the base material 116. In another embodiment, the base material 116 is adhered to the frame 110 using an adhesive, glue or an attachment mechanism. In another embodiment, multiple layers can be formed by pouring a same or different compositions for a present layer after curing a previous layer.

Conventional cover slip lids using adhesive to attempt to secure optical fibers are highly susceptible to optical fiber “pull-out,” and misalignment under the application of various external forces and CPI related issues. The embodiments of the present invention provide a cushioned preloaded cover or lid 130 that employs a compliant solid or mushy polymer material, e.g., an organic polymer, to hold the optical fibers in place. High longitudinal friction forces prevent pull-out of the fibers, and preloading forces prevent misalignment. While FIG. 5 shows a unform cushioning surface 115, the cushioning surface can include a textured surface, having protrusions, such as uniformly distributed dots, lines extending in the direction of arrow “A”, perpendicular to arrow “A”, on diagonals, etc. Other textures may also be employed and can be formed during the molding of the base material 116. In a particularly useful embodiment, the cushioning surface 115 can include holes to improve deformability of the compliant base material 116. The holes can be distributed in any useful pattern. In other useful embodiments, the base material 116 can include a matrix having particles or fillers disbursed therein to differing materials or properties to achieve desired mechanical properties.

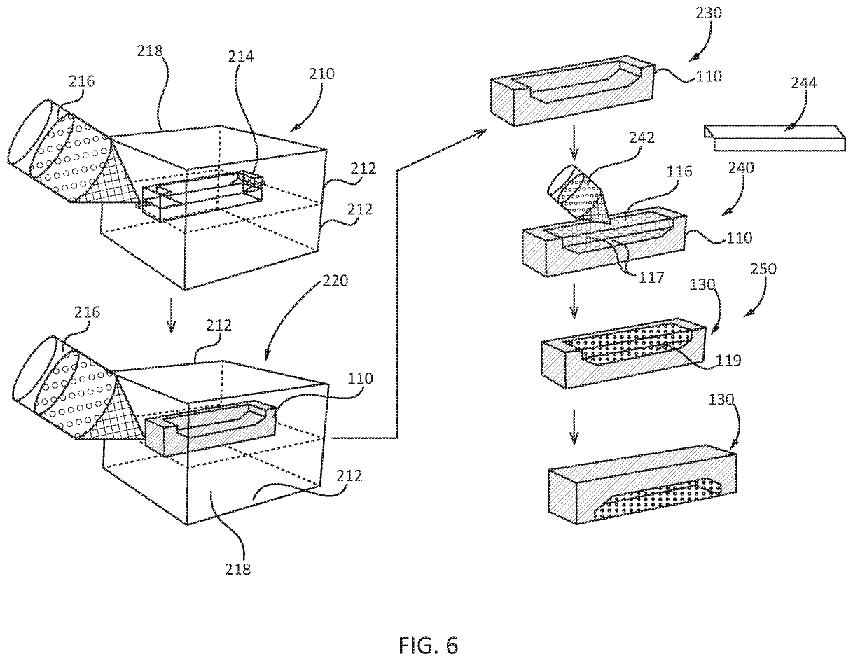

Referring to FIG. 6, a method for making a lid is illustratively shown in accordance with one embodiment. A mold 218 is fabricated with a cavity 214 in stage 210. The mold 218 can include two halves 212 for casting or injection molding the frame portion of the lid. Next, the mold halves are aligned and the mold assembled and secured or clamped to close and hold the mold 218. Next, the injection/casting material is prepared and introduced into the mold 218. Constituent feeding materials are introduced from a hopper 216 or reservoir and can include metal powder, ceramic powder, plastics/polymers, binders, etc. depending on the material selected for the frame. The material is introduced into the mold 218 under pressure to fill a cavity 214 in the shape of the frame for the lid.

In stage 220, after filling the mold 218 (e.g., by injection molding), post-processing can be performed, e.g., sintering/polymerization, etc. to create part in a molded or cast frame 110. The frame 110 is ejected from the mold 218 after cooling or dwelling.

In stage 230, any flash is removed from the frame 110. The frame 110 can be cleaned. In stage 230, the frame 110 is filled with the compliant solid base material 116 (e.g., elastic polymer in liquid form 242). The compliant solid base material 116 can include fillers 119 such as particles or air pockets to achieve the mechanical properties desired. The compliant solid base material 116 can include one or more layers 117 of material. The layers 117 may be applied in succession and include different properties or materials to achieve the mechanical properties desired. Texturing of a top surface of the compliant solid base material 116 can be performed by employing a textured form 244, stamp or inset profile for applying the texture in the top surface. For example, the textured form 244 can disrupt the surface of the compliant solid base material 116 to form ribs, dots, trenches or other textures in the surface of the compliant solid base material 116.

In stage 250, the compliant solid base material 116 is cured. The base material 116 adheres to the frame 110 during the cure process. After the curing process, the lid 130 is formed and ready for installation.

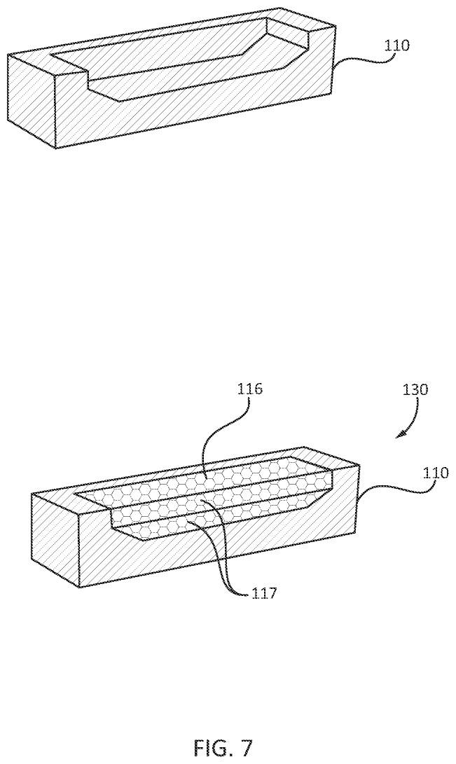

Referring to FIG. 7, in another embodiment, the frame 110 can be fabricated as described with respect to FIG. 6. Then, the base material 116 in a solid form can be applied to the frame 110 using an adhesive, glue or an attachment mechanism. The adhesive or glue can include, e.g., UV-curable adhesive. The attachment mechanism can include an interference fit, snaps, tongue and groove connections or any other suitable mechanical connection. The base material 116 can include layers 117 and/or fillers 119 (FIG. 6) as needed to achieve the desired mechanical properties.

Having described preferred embodiments of systems, devices and methods (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A lid for a photonic device, comprising:
a resilient frame configured to bridge transversely over one or more optical fibers in a region of the photonic device, the resilient frame including a span that defines a span direction, the resilient frame further including end portions that are disposed transversely to the span to form an internal region of the frame; and
a compliant solid base material formed within the internal region of the frame and attached to the frame along the span;
the resilient frame being configured to transversely span over one or more optical fibers and preload the one or more optical fibers with the compliant solid base material when secured to the photonic device.

2. The lid as recited in claim 1, wherein the end portions are secured to the photonic device with an adhesive.

3. The lid as recited in claim 1, wherein the compliant solid base material is configured to engage the one or more optical fibers and contour to a shape of the one or more optical fibers to fill lateral spaces around the one or more optical fibers.

4. The lid as recited in claim 1, wherein the compliant solid base material includes an elastomeric polymer material.

5. The lid as recited in claim 1, wherein the preload includes a compression pressure on the one or more optical fibers of less than 5 psi.

6. The lid as recited in claim 1, wherein the frame includes one or more of plastic, metal and/or ceramic.

7. A lid for a photonic device, comprising:
a resilient frame configured to bridge transversely over one or more optical fibers in a region of the photonic device; and
a compliant solid base material formed on a first side of the frame;
the one or more fibers being positioned on the photonic device, and the resilient frame being configured to transversely span over the one or more optical fibers and preload the one or more fibers with the compliant solid base material when the frame is secured to the photonic device.

8. The lid as recited in claim 7, wherein the compliant solid base material engages the one or more optical fibers and contours to a shape of the one or more optical fibers to fill lateral spaces around the one or more optical fibers.

9. The lid as recited in claim 7, wherein the compliant solid base material includes an elastomeric polymer material.

10. The lid as recited in claim 7, wherein the preload includes a compression pressure on the one or more optical fibers of less than 5 psi.

11. The lid as recited in claim 7, wherein the photonic device includes one or more channels that receive the one or more optical fibers.

12. The lid as recited in claim 7, wherein the region of the photonic device includes a transition region between waveguides on the photonic device and the one or more fibers, which extend off the photonic device.

13. The lid as recited in claim 7, wherein the resilient frame includes a span that defines a span direction, the resilient frame further including end portions that are disposed transversely to the span.

14. The lid as recited in claim 13, wherein the end portions are secured to the photonic device with an adhesive.

15. The lid as recited in claim 7, wherein the compliant solid base material is fully removeable from the one or more optical fibers.

16. A lid assembly for a photonic device, comprising:
a resilient frame configured to bridge transversely over one or more optical fibers in a region of the photonic device, the resilient frame including a span that defines a span direction, the resilient frame further including end portions that are disposed transversely to the span to form an internal region of the frame;
a compliant solid base material formed with the internal region of the frame and attached to the frame along the span; and
a fiber receiving trough disposed in the photonic device is configured to receive the one or more optical fibers, the one or more fibers being positioned on the photonic device in communication with corresponding waveguides disposed on the photonic device;
the resilient frame being configured to transversely span over the one or more optical fibers and preload the one or more fibers with the compliant solid base material when secured to the photonic device in a transition region between the waveguides on the photonic device and the one or more fibers, which extend off the photonic device.

17. The lid assembly as recited in claim 16, wherein the compliant solid base material engages the one or more optical fibers and contours to a shape of the one or more optical fibers to fill lateral spaces around the one or more optical fibers.

18. The lid assembly as recited in claim 16, wherein the compliant solid base material includes an elastomeric polymer material.

19. The lid assembly as recited in claim 16, wherein the preload includes a compression pressure on the one or more optical fibers of less than 5 psi.

20. The lid assembly as recited in claim 16, wherein the compliant solid base material is fully removeable from the one or more optical fibers.
